(19) United States
(12) Patent Application Publication
(10) Pub. No.: US 2008/0126249 A1
(43) Pub. Date: May 29, 2008

(54) System and method for providing remote financial services

(76) Inventor: Jose Garcia, Williamston, SC (US)

Correspondence Address: MCNAIR LAW FIRM, P.A., P.O. BOX 10827, GREENVILLE, SC, 29603-0827, US

(21) Appl. No.: 11/983,475

(22) Filed: Nov. 9, 2007

Related U.S. Application Data
(60) Provisional application No. 60/857,859, filed on Nov. 10, 2006.
(60) Provisional application No. 60/922,993, filed on Apr. 12, 2007.

(51) Int. Cl. G06Q 40/00

(52) U.S. Cl. 705/42; 705/35

(57) ABSTRACT

A self-propelled mobile platform having systems for delivering credit instruments, such as paychecks, and providing check cashing, money transfers, bill payments, money orders, phone cards, debit cards, and ATM services at remote sites for customers or potential customers who either do not have a banking relationship with a financial institution or desire the convenience of receiving financial services at a location other than an established financial institution.

### CLAIM OF PRIORITY

This patent application claims priority on U.S. Provisional Patent Application No. 60/857,859, filed Nov. 10, 2006, and U.S. Provisional Patent Application No. 60/922,993, filed Apr. 12, 2007.

### FIELD OF THE INVENTION

This invention is directed to a system and method for providing financial services to remote locations. More particularly, this invention is directed toward a system and method for delivering paychecks and providing check cashing, money transfers, bill payments, money orders, and ATM services at remote sites for customers or potential customers who either do not have a banking relationship with a financial institution or desire the convenience of receiving financial services at a location other than an established financial institution.

### BACKGROUND OF THE INVENTION

There is a need in the market for financial services tailored toward individuals who do not have traditional banking relationships (the “un-banked”). There may be many reasons an individual does not have a relationship with a banking institution which can include low income, unsophistication, poor credit rating, an unwillingness to use financial organizations or lack of citizenship or immigration documentation. An individual who has had a history of insufficient funds, activity or a very poor credit rating, may not even be eligible to open a checking account in a traditional financial institution. Further, the cultural or past experiences of an individual may influence an individual's decision to choose not to form a relationship with a traditional financial institution. There are several countries which do not have a stable regulated financial industry as in the United States, and therefore, when such individuals relocate to the United States, they have an aversion toward the financial banking institution.

It is problematic for individuals who receive paychecks from their employers, but who are unable to conduct any other transaction except to cash their checks. These individuals may not be able to leave their work location to cash their checks, would not have a bank account which is required at many financial institutions in order to even cash the check, or may receive their checks after banking hours. Therefore, these individuals do not have access to cash, which for low-income wage earners can put a financial strain on the individual and his family. The ability to receive a payroll check and conduct a financial transaction at the place of work reduces employers' concerns over loss of productivity, as well as safety concerns associated with wage earners carrying the entire paycheck in cash since they are unable to deposit the money in a financial institution.

There is a significant problem with security associated with theft from individuals who do not have established banking relationships. This is particularly true for individuals who are in the United States, but working with an illegal status. Individuals can be specific targets when traditionally they cash their entire check, receive all their cash at once, and are extremely hesitant to report the crime due to their illegal status. Therefore, there is a need to provide a service to such individuals which does not require cashing of the entire check and allows the individual to benefit from the payroll without having to carry its entire balance in cash once the payroll check has been received.

Therefore, there is a need to provide financial services to individuals who do not have banking relationships with established financial institutions, but desire to enjoy financial services which can be delivered at a remote site such as a place of work.

### SUMMARY OF THE INVENTION

The above objective is accomplished according to the present invention by providing a system for delivering financial services to employees at a remote location without requiring the employees to have a prior relationship with a financial institution comprising, an operations center computer readable medium in communications with the financial institution; a set of authorized financial institution information stored on the operations center computer readable medium representing financial institutions that are authorized to have credit instruments applied against the financial instruction's accounts; a self-propelled mobile platform having a communications link to the operations center computer readable medium and a power supply; an image capturing device carried by the mobile platform for capturing images of a physical credit instrument presented by the employee to an operator of the mobile platform for redemption; a mobile computer readable medium carried by the mobile platform in communications with the image capturing device; a display in communications with the mobile computer readable medium for displaying images to the operator of the mobile platform; a set of redemption information stored on the mobile computer readable medium representing information concerning redemption of the credit instrument; a set of operations computer readable instructions embodied in the operations center computer readable medium for receiving payroll funding information from the financial institution representing that funds for a payroll are available for having credit instruments applied against and transmitting redemption information to the remote computer readable medium representing that the financial institution is an authorized financial institution and that the payroll has been funded; and, a set of mobile computer readable instructions embodied in the mobile computer readable medium for capturing an image of the credit instrument presented to the operator by the employee, displaying the credit instrument image on the display so that the image can be viewed by the operator, receiving credit instrument information entered by the operator according to the credit instrument representing the credit instrument presented by the employee, verifying the credit instrument can be redeemed according to the credit information and the redemption information, and redeeming the credit instrument if the credit instrument is authorized for redemption according to the redemption information.

In a further embodiment of the invention, the system includes authorized account information contained within the redemption information representing authorized accounts that the credit instrument is to be drawn against; and, the mobile computer readable instructions for redeeming the credit instrument if the credit instrument is authorized for redemption according to the redeeming information include instructions for verifying that the credit instruments is to be drawn against an authorized account.

In a further embodiment of the invention, the mobile computer readable instructions include instructions for displaying rejection information on the display representing that the credit instrument cannot be redeemed according to the redemption information so that the operator can inform the employee presenting the credit instrument the reason the credit instrument cannot be redeemed.

In a further embodiment of the invention, the mobile computer readable instructions include instructions for transmitting the captured credit instruments image to the operations computer readable medium so that a copy of the captured credit instrument image can be stored at the central computer readable medium.

In a further embodiment of the invention, the mobile computer readable instructions for redeeming the credit instrument if the credit instrument is authorized for redemption according to the redeeming information include instructions for creating bank wiring instructions for wiring at least a portion of the amount of the credit instrument to a third party.

In a further embodiment of the invention, the mobile computer readable instructions include instructions for transmitting the bank wiring instructions to the operations computer readable medium; and, the set of operations computer readable instructions include instructions for transmitting the bank wiring instructions to a wiring institution so that the bank wiring instructions can be processed.

In a further embodiment of the invention, the remote computer readable instructions include instructions for transmitting the bank wiring instructions to the operations center compute readable medium; and, the set of operations computer readable instructions include instructions for transmitting the bank wiring instructions to the financial institution so that the bank wiring instructions can be processed.

In a further embodiment of the invention, the mobile computer readable instructions for redeeming the credit instrument if the credit instrument is authorized for redemption according to the redeeming information include instructions for issuing at least one of a phone card and a debit card for at least a portion of the amount of the credit instrument so that the employee can receive the phone card and the debit card having a credit amount.

In a further embodiment of the invention, a card printer in communication with the computer readable medium; and, the computer readable instructions for redeeming the credit instruction if the credit instrument is authorized for redemption according to the redeeming information include instructions for printing the phone card and debit card via the card printer.

### DESCRIPTION OF THE DRAWINGS

This invention will more readily be understood by referencing the following drawings:

FIG. 1 is a schematic of the present invention;

FIG. 2 is a schematic of the present invention;

FIG. 3 is a flowchart of the present invention; and,

FIG. 4 is a flowchart of the present invention.

### DETAILED DESCRIPTION OF THE INVENTION

An object or module is a section of computer readable code embodied in a computer. The detailed description that follows may be presented in terms of program procedures executed on a computer or network of computers. These procedural descriptions are representations used by those skilled in the art to most effectively convey the substance of their work to others skilled in the art. These procedures herein described are generally a self-consistent sequence of steps leading to a desired result. These steps require physical manipulations of physical quantities such as electrical or magnetic signals capable of being stored, transferred, combined, compared, or otherwise manipulated readable medium that is designed to perform a specific task or tasks. Actual computer or executable code or computer readable code may not be contained within one file or one storage medium but may span several computers or storage mediums. The term “host” and “server” may be hardware, software, or combination of hardware and software that provides the functionality described herein.

The present invention is described below with reference to flowchart illustrations of methods, apparatus (“systems”) and computer program products according to the invention. It will be understood that each block of a flowchart illustration can be implemented by a set of computer readable instructions or code. These computer readable instructions may be loaded onto a general purpose computer, special purpose computer, or other programmable data processing apparatus to produce a machine such that the instructions will execute on a computer or other data processing apparatus to create a means for implementing the functions specified in the flowchart block or blocks.

These computer readable instructions may also be stored in a computer readable medium that can direct a computer or other programmable data processing apparatus to function in a particular manner, such that the instructions stored in a computer readable medium produce an article of manufacture including instruction means that implement the functions specified in the flowchart block or blocks. Computer program instructions may also be loaded onto a computer or other programmable apparatus to produce a computer executed process such that the instructions are executed on the computer or other programmable apparatus provide steps for implementing the functions specified in the flowchart block or blocks. Accordingly, elements of the flowchart support combinations of means for performing the special functions, combination of steps for performing the specified functions and program instruction means for performing the specified functions. It will be understood that each block of the flowchart illustrations can be implemented by special purpose hardware based computer systems that perform the specified functions, or steps, or combinations of special purpose hardware or computer instructions. The present invention is now described more fully herein with reference to the drawings in which the preferred embodiment of the invention is shown. This invention may, however, be embodied any many different forms and should not be construed as limited to the embodiment set forth herein. Rather, these embodiments are provided so that this disclosure will be thorough and complete and will fully convey the scope of the invention to those skilled in the art.

The present invention provides for the processing and distribution of credit instruments. As used herein, credit instrument(s) refers to a wide variety of monetary items used in the regular course of commerce, including but not limited too, cash, paychecks, money orders, phone cards, debit cards, credit cards, and the like. By providing the ability to process credit instruments, such as by check cashing, money transfers, bill payments, credit, and ATM services, the present invention allows for a variety of financial services at remote sites for customers or potential customers who either do not have a banking relationship with a financial institution or desire the convenience of receiving financial services at a location other than an established financial institution.

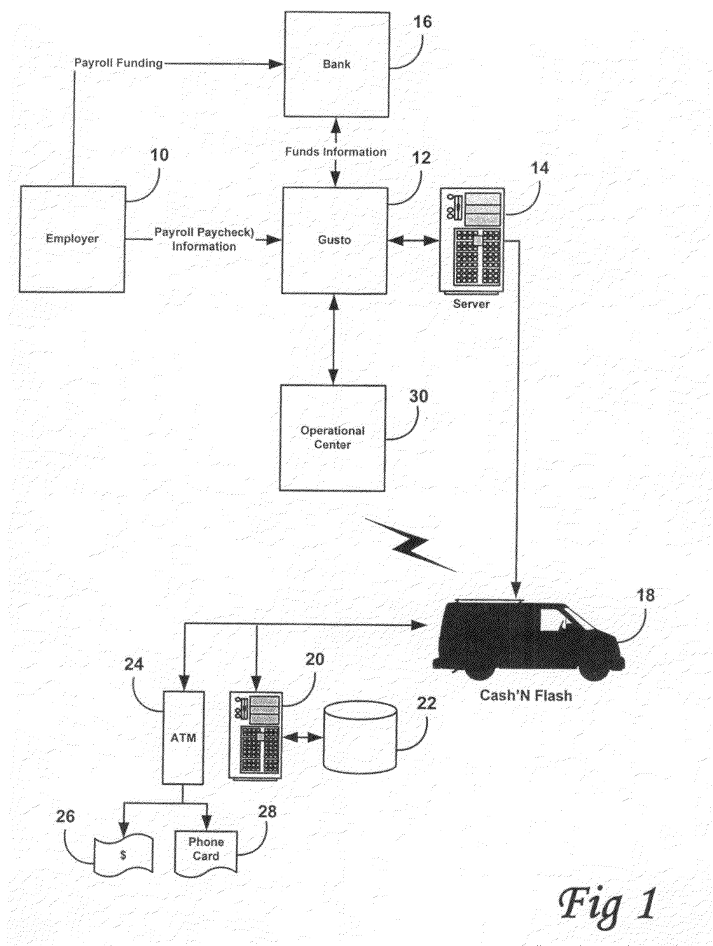

Referring now to FIG. 1, the employer 10 of the un-banked individual who does not have a traditional relationship with a financial institution has a desire to run payroll. When payroll is to be transmitted to un-banked individuals, the employer sends paycheck information to a computer readable medium 14 at location 12 and wires funds to bank 16. Computer readable medium 14 can access funds information from bank 16 to both verify and communicate transactions with bank 16. A mobile vehicle 18 can receive paycheck information and also has a mobile computer readable medium 20 and mobile database 22 where financial information is stored. Further, paychecks can be printed at location 12 and delivered to van 18. The van can then travel to a remote job site and distribute the paychecks to the un-banked. Once the paychecks are distributed, the un-banked individual can present the check at vehicle 18 and cash the paycheck. The financial information associated with the individual stored in remote computer readable medium 22 can be updated to reflect the cashing of the check and this information can travel back to location 12 and to bank 16. When a check is cashed, an image of the check and the un-banked individual's identification information can be stored in the remote computer medium so that a record of the transaction with the actual check image is accessible for future review.

The information can then be stored in permanent medium, such as CD, DVD, Tape Back-up, Write-Only-Read Many (WORM) drives, optical drives or other such computer readable medium allowing long term storage of electronic information. In the event that it is necessary to keep such records, for example due to regulations, investigation or audit needs, these records allow for the reproduction of transaction from mobile computer medium or long term storage medium. Therefore, an audit trail can be provided from the financial information stored and the imaging of documents from the transaction can provide support to verify the audit trail.

As well as providing cash to the un-banked individual when cashing a check, vehicle 18 can also contain an ATM machine which can dispense cash 26 or phone card 28 from a debit card presented at vehicle 18. A phone card can also be distributed independently of the ATM machine as part of the service provided from vehicle 18. Further, wire transfer services can be performed from the vehicle.

For the operators of vehicle 18, in the event that there are operational logistical issues, an operation system 30 can be used to communicate with each vehicle 18 and can assist with travel routes, issues, or any communications between the vehicles and a central operational center.

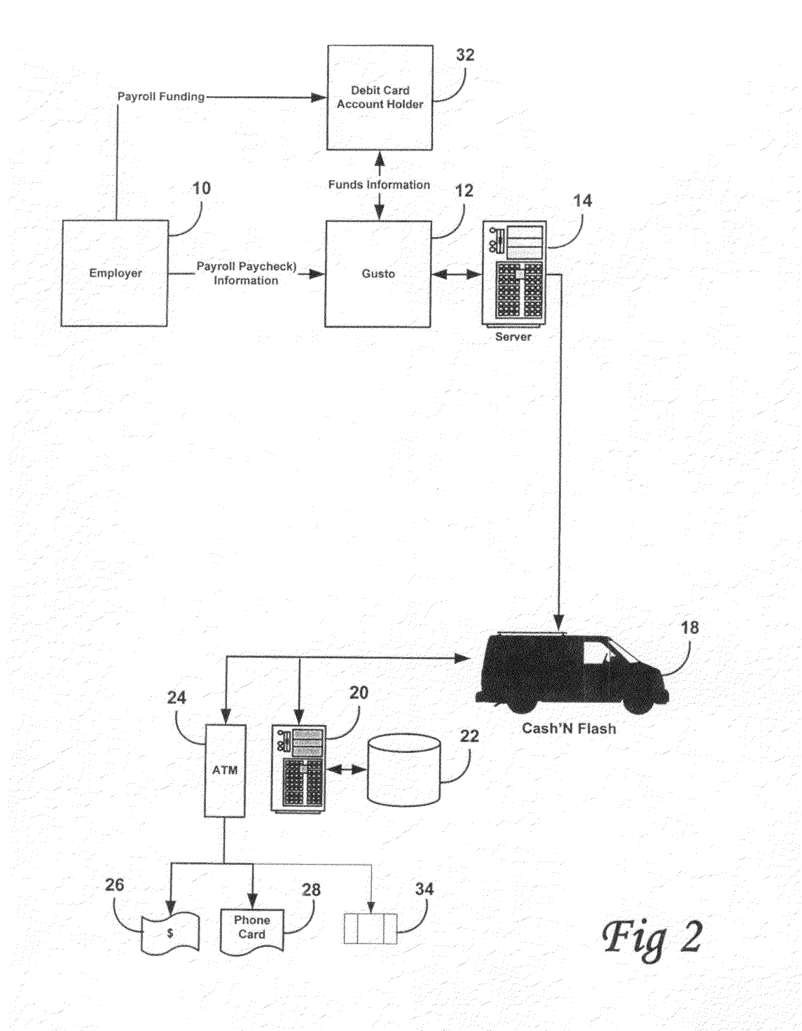

Referring to FIG. 2, this invention can be used to distribute debit cards 34 to the un-banked individual rather than having cash distributed to the un-banked individual through cashing of his paycheck. Employer 10 funds a debit card account 32 which can communicate funds information within location 12 and such information can be stored on a computer readable medium 14. Therefore, the information associated with an un-banked individual's debit card can be updated by employer 10 so that when the debit card 34 is used, for example, at ATM 24, there is communication with the debit card account holder 32 that can be used to allow the un-banked individual to withdraw funds as needed rather than having to cash the entire paycheck. This provides for a more secure financial transaction since the un-banked individual can use the debit card as cash reducing the risk of theft as well as the need to carry the balance of the payroll check in cash. Further, automatic ball pay services can be setup and preformed by using the debit card account for automatic withdrawals for paying bills.

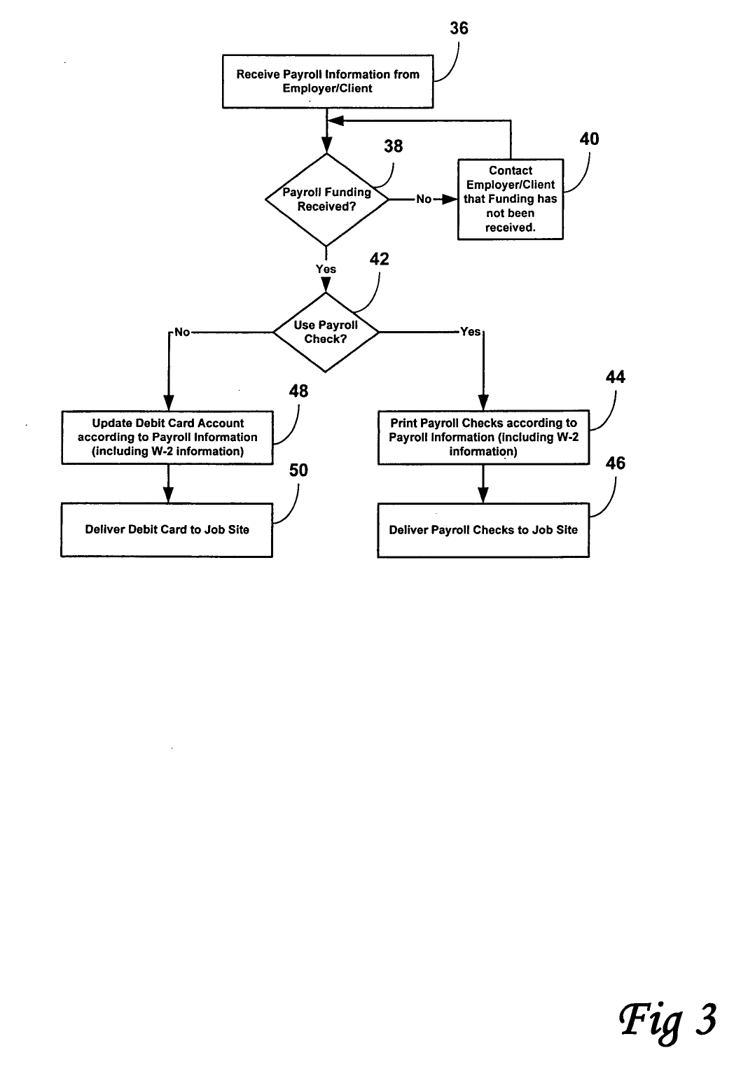

Referring now to FIG. 3, payroll information is received from the employer/client in step 36. If the payroll funding is also received in step 38, determination is made at step 42 on whether the payroll check will be used. If so, the payroll check is printed at step 44 which includes W-2 and other information and the payroll check is delivered to the job site in step 46. If a payroll check is not to be used, the debit card account information is updated in step 48 and a debit card can be delivered to the job site for the un-banked individual at step 50. In the event that the individual already has a debit card, the account information is simply updated without the need to deliver a new debit card to the un-banked individual. In step 38, if payroll funding has not been received, the employer is contacted that funds have not been received in step 40 and the process is suspended until funds are received from the employer.

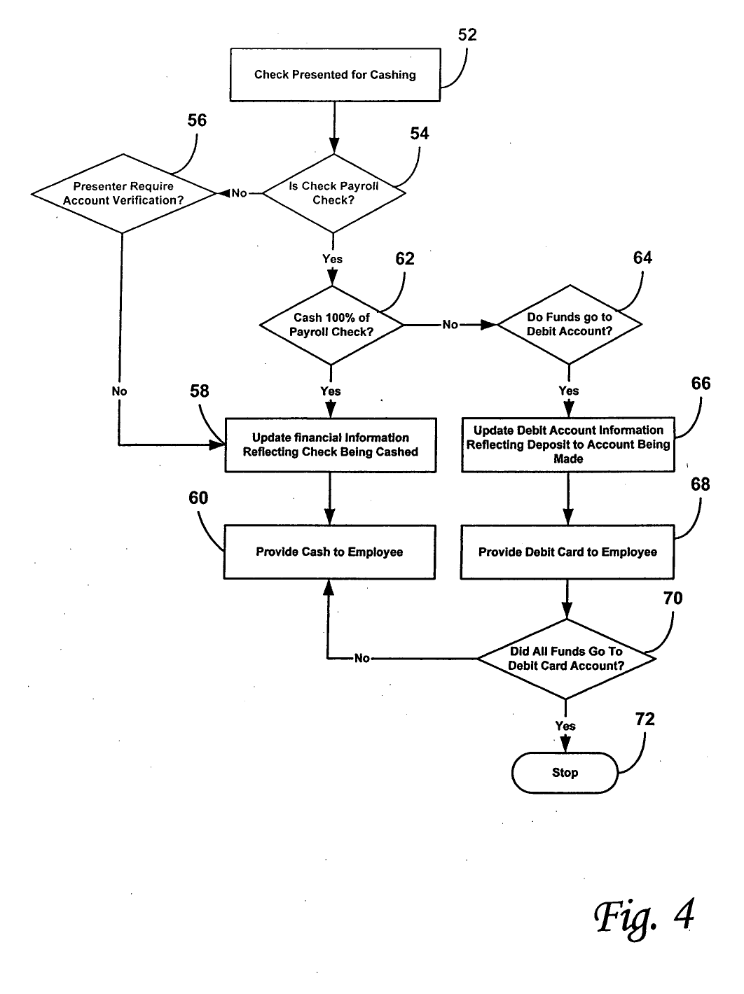

Referring now to FIG. 4, when a check is presented for cashing at the vehicle 18 at step 52, a determination is made as to whether it is a payroll check from a client in step 54 or whether the check is from a third party. If the check is from a client, a determination at step 62 is made on whether to cash 100% of the payroll check. If the answer is yes, financial information is updated reflecting the check being cashed at step 58 and cash is provided to the un-banked employee at step 60. In the event that 100% of the payroll check is not cashed, a determination is made on whether the funds go to a debit account in step 64. If the answer is yes, that information is updated at step 66 and the debit card can be provided to the employee at step 68 in the event the employee does not have one. If all the funds went to the debit card account in step 70, then the process in step 72, otherwise, the balance from the debit card can be provided in cash to the employee at step 60. In the event it is not a payroll check, an account verification process is conducted at step 56 and if no verification is required or the issuing party of the check does not require verification, financial information reflecting the check being cashed can be stored at step 58 and cash be provided to the employee at step 60.

While a preferred embodiment of the invention has been described using specific terms, such description is for illustrative purposes only, and it is to be understood that changes and variations may be made without departing from the spirit or scope of the following claims.

What is claimed is:

1. A vehicle for delivering financial services to employees at a remote location without requiring the employees to have a prior relationship with a financial institution comprising:
a self-propelled mobile platform having a power supply;
an image capturing device carried by said mobile platform for capturing images of a physical credit instrument presented by the employee to an operator of said mobile platform for redemption;
a computer readable medium carried by said mobile platform in communication with said image capturing device;
a display in communication with said computer readable medium for displaying images to the operator of said mobile platform;
a set of redemption information stored on said computer readable medium representing information concerning redemption of said credit instrument; and,
a set of computer readable instructions embodied in said central computer readable medium for capturing an image of said credit instrument presented to the operator by the employee, displaying said credit instrument image on said display so that said image can be viewed by the operator, receiving credit instrument information entered by the operator according to said credit instrument representing said credit instrument presented by the employee, verifying said credit instrument can be redeemed according to said credit information and said redemption information, and redeeming said credit instrument if said credit instrument is authorized for redemption according to said redeeming information.

2. The system of claim 1 including:
authorized account information contained within said redemption information representing authorized accounts that said credit instrument is to be drawn against; and,
said computer readable instructions for redeeming said credit instrument if said credit instrument is authorized for redemption according to said redeeming information include instructions for verifying that said credit instrument is to be drawn against said authorized account.

3. The system of claim 1 wherein said computer readable instructions include instructions for displaying rejection information on said display representing that said credit instrument cannot be redeemed according to said redemption information so that the operator can inform the employee presenting the credit instrument the reason said credit instrument cannot be redeemed.

4. The system of claim 1 including:
a communications link carried by said mobile platform and in communications with said computer readable medium; and,
said computer readable instructions include instructions for receiving redemption information from a central computer readable medium, storing said redemption information on said computer readable medium and transmitting said captured credit instrument image to said central computer readable medium so that a copy of said captured credit instrument image can be stored on said central computer readable medium.

5. The system of claim 1 wherein said computer readable instructions for redeeming said credit instrument if said credit instrument is authorized for redemption according to said redeeming information include instructions for creating bank wiring instructions for wiring at least a portion of the amount of said credit instrument to a third party.

6. The system of claim 5 including:
a communications link carried by said mobile platform and in communications with said computer readable medium; and,
said computer readable instructions include instructions for transmitting said bank wiring instructions to a wiring institution so that said bank wiring instructions can be processed.

7. The system of claim 1 wherein said computer readable instructions for redeeming said credit instrument if said credit instrument is authorized for redemption according to said redeeming information include instructions for issuing at least one of a phone card and a debit card for at least a portion of the amount of said credit instrument so that the employee can receive said phone card and said debit card having a credit amount.

8. The system of claim 7 including:
a card printer in communication with said computer readable medium; and,
said computer readable instructions for redeeming said credit instrument if said credit instrument is authorized for redemption according to said redeeming information include instructions for printing said phone card and said debit card via said card printer.

9. The system of claim 1 including:
a write once storage device carried by said mobile platform and in communications with said computer readable instructions for writing information onto a write once computer readable medium; and,
said set of computer readable instructions include instructions for storing said credit instrument image on said write once computer readable medium using said write once storage device.

10. A system for delivering financial services to employees at a remote location without requiring the employees to have a prior relationship with a financial institution comprising:
an operations center computer readable medium in communications with the financial institution;
a set of authorized financial institution information stored on said operations center computer readable medium representing financial institutions that are authorized to have credit instruments applied against said financial instruction's accounts;
a self-propelled mobile platform having a communications link to said operations center computer readable medium and a power supply;
an image capturing device carried by said mobile platform for capturing images of a physical credit instrument presented by the employee to an operator of said mobile platform for redemption;
a mobile computer readable medium carried by said mobile platform in communications with said image capturing device;
a display in communications with said mobile computer readable medium for displaying images to the operator of said mobile platform;
a set of redemption information stored on said mobile computer readable medium representing information concerning redemption of said credit instrument;
a set of operations computer readable instructions embodied in said operations center computer readable medium for receiving payroll funding information from said financial institution representing that funds for a payroll are available for having credit instruments applied against and transmitting redemption information to said remote computer readable medium representing that said financial institution is an authorized financial institution and that said payroll has been funded; and,
a set of mobile computer readable instructions embodied in said mobile computer readable medium for capturing an image of said credit instrument presented to the operator by the employee, displaying said credit instrument image on said display so that said image can be viewed by the operator, receiving credit instrument information entered by the operator according to said credit instrument representing said credit instrument presented by the employee, verifying said credit instrument can be redeemed according to said credit information and said redemption information, and redeeming said credit instrument if said credit instrument is authorized for redemption according to said redemption information.

11. The system of claim 10 including:
authorized account information contained within said redemption information representing authorized accounts that said credit instrument is to be drawn against; and,
said mobile computer readable instructions for redeeming said credit instrument if said credit instrument is authorized for redemption according to said redeeming information include instructions for verifying that said credit instruments is to be drawn against an authorized account.

12. The system of claim 10 wherein said mobile computer readable instructions include instructions for displaying rejection information on said display representing that said credit instrument cannot be redeemed according to said redemption information so that the operator can inform the employee presenting the credit instrument the reason said credit instrument cannot be redeemed.

13. The system of claim 10 wherein said mobile computer readable instructions include instructions for transmitting said captured credit instruments image to said operations computer readable medium so that a copy of said captured credit instrument image can be stored at said central computer readable medium.

14. The system of claim 10 wherein said mobile computer readable instructions for redeeming said credit instrument if said credit instrument is authorized for redemption according to said redeeming information include instructions for creating bank wiring instructions for wiring at least a portion of the amount of said credit instrument to a third party.

15. The system of claim 14 wherein:
said mobile computer readable instructions include instructions for transmitting said bank wiring instructions to said operations computer readable medium; and,
said set of operations computer readable instructions include instructions for transmitting said bank wiring instructions to a wiring institution so that said bank wiring instructions can be processed.

16. The system of claim 15 wherein:
said remote computer readable instructions include instructions for transmitting said bank wiring instructions to said operations center compute readable medium; and,
said set of operations computer readable instructions include instructions for transmitting said bank wiring instructions to said financial institution so that said bank wiring instructions can be processed.

17. The system of claim 10 wherein said mobile computer readable instructions for redeeming said credit instrument if said credit instrument is authorized for redemption according to said redeeming information include instructions for issuing at least one of a phone card and a debit card for at least a portion of the amount of said credit instrument so that the employee can receive said phone card and said debit card having a credit amount.

18. The system of claim 17 including:
a card printer in communication with said computer readable medium; and,
said computer readable instructions for redeeming said credit instruction if said credit instrument is authorized for redemption according to said redeeming information include instructions for printing said phone card and debit card via said card printer.

19. A system for delivering financial services to employees at a remote location without requiring the employees to have a prior relationship with a financial institution comprising:
an operations center computer readable medium in communications with the financial institution;
a set of operations computer readable instructions embodied in said operations center computer readable medium for receiving payroll information from the financial institution representing payroll obligations of an employer, receiving payroll funding information from said financial institution representing that funds for a payroll are available for having credit instruments applied there against, and generating credit instruments according to said payroll information once said funding information is received;
a self-propelled mobile platform having a power supply and for storing said credit instruments generated by said set of operations computer readable instructions;
a mobile computer readable medium carried by said mobile platform in communications with said operations center computer readable medium;
an image capturing device in communications with said mobile computer readable medium;
a display in communications with said computer readable medium; and
a set of mobile computer readable instructions embodied in said computer readable medium for receiving payroll information from said operations center computer readable medium, modifying said payroll information to represent that said credit instruments have been distributed to employees, capturing an image of said credit instrument presented to the operator for redemption after being distributed to the employees, displaying said credit instrument image on said display so that said image can be viewed by the operator, and redeeming said credit instrument.

20. The system of claim 19 wherein said mobile computer instructions for redeeming said credit instrument include instructions for creating bank wire instructions for wiring at least a portion of the amount of said credit instrument to a third party.

21. The system of claim 19 wherein said remote computer readable instructions for redeeming said credit instrument include instructions for issuing at least one of a phone card and a debit card for at least a portion of the amount of said credit instrument so that the employee can receive said phone card and debit card having a credit amount.
